(19) United States
(12) Patent Application Publication
(10) Pub. No.: US 2026/0012311 A1
(43) Pub. Date: Jan. 8, 2026

(54) METHOD AND APPARATUS OF SUPPORTING SPATIAL ELEMENT ADAPTION

(71) Applicant: LENOVO (BEIJING) LIMITED, Beijing (CN)

(72) Inventors: Hongmei LIU, Beijing (CN); Zhi YAN, Beijing (CN); Yuantao ZHANG, Beijing (CN); Ruixiang MA, Beijing (CN); Haiming WANG, Beijing (CN)

(21) Appl. No.: 19/112,101

(22) PCT Filed: Dec. 15, 2022
(86) PCT No.: PCT/CN2022/139403

§ 371 Date: Mar. 14, 2025

(51) Int. Cl. H04L 5/00; H04W 72/231

(52) U.S. Cl. CPC H04L 5/0051; H04L 5/0044; H04W 72/231

(57) ABSTRACT

Embodiments of the present application relate to a method and apparatus of supporting spatial element adaption. An exemplary apparatus, e.g., a UE may include: a transceiver and a processor coupled to the transceiver. The processor is configured to: receive a first signaling indicating at least one RS set, wherein, each RS set includes at least one RS resource; determine at least one RS group based on the at least one RS set; and perform reporting based on at least one of: the at least one RS group or the at least one RS set.

### TECHNICAL FIELD

Embodiments of the present application generally relate to wireless communication technology, especially to a method and apparatus of supporting spatial element adaption.

### BACKGROUND

Wireless communication systems are widely deployed to provide various telecommunication services such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems such as long term evolution (LTE) systems, LTE-advanced (LTE-A) systems, or LTE-A Pro systems, and fifth generation (5G) systems which may also be referred to as new radio (NR) systems. However, wireless communication system still needs to evolve to pursue better service quality, better service experience and lower cost.

According to RAN1 #111 agreement, it is needed to further study techniques and enhancements for the adaptation of spatial elements, which includes but not limited to the following aspects: enhancements on (CSI) reference signal (RS) (re) configuration, CSI/radio resource management (RRM)/radio link monitoring (RLM) measurements, CSI reporting (e.g., multiple CSI reports), and beam management for gNB to switch between different spatial domain configurations etc.

### SUMMARY OF THE DISCLOSURE

At least one objective of the present application is to provide a technical solution of supporting spatial element adaption, which involves determining RS (or RS resource) for measurement (e.g., CSI-RS measurement and/or synchronization signal block (SSB) measurement), and then reporting based on the RS measurement to switch among different spatial domain configurations.

Some embodiments of the present application provide an exemplary remote apparatus, e.g., a UE, which includes a transceiver and a processor coupled to the transceiver. The processor is configured to: receive a first signaling indicating at least one RS set, wherein, each RS set includes at least one RS resource; determine at least one RS group based on the at least one RS set; and perform reporting based on at least one of: the at least one RS group or the at least one RS set.

Some other embodiments of the present application provide an exemplary wireless communication method, e.g., a method performed in UE, which includes: receiving a first signaling indicating at least one RS set, wherein, each RS set includes at least one RS resource; determining at least one RS group based on the at least one RS set; and performing reporting based on at least one of: the at least one RS group or the at least one RS set.

Some yet other embodiments of the present application provide a radio access network (RAN) node, e.g., a gNB, which includes: a transceiver; and a processor coupled to the transceiver, wherein the processor is configured to: transmit a first signaling indicating at least one RS set, wherein, each RS set includes at least one RS resource; determine at least one RS group based on the at least one RS set; and receive reporting based on at least one of the at least one RS group or the at least one RS set.

In some embodiments of the present application, the at least one RS group is the at least one RS set respectively.

In some embodiments of the present application, the processor is configured to: receive a second signaling indicating information of the following: at least one of: a window size of RS set or at least one time instance of RS set; or a window size of RS set and an offset of RS set; or a window size of RS set, an offset of RS set and at least one time instance of RS set; or one or more RS resource indexes within a RS set of the at least one RS set; or a RS set number within a RS group; or a number of time instance of RS set within a RS group; or a RS resource number within a RS group; or a number of RS groups; or a number of elements in each RS group; or at least one port index within each RS resource; and determine the at least one RS group based on the at least one RS set and the information indicated in the second signaling.

According to some embodiments of the present application, in the case that the at least one RS resource within a RS set is periodic RS resource, the window size and the offset are in unit of periodicity of the at least one RS resource.

According to some embodiments of the present application, in the case that the second signaling indicates the window size, the at least one time instance of RS set will be determined based on the window size.

According to some embodiments of the present application, in the case that the second signaling indicates the window size and offset, the at least one time instance of RS set will be determined based on the window size and offset.

According to some embodiments of the present application, each element in a RS group of the at least RS group is a RS resource pair. In some scenarios, each RS resource pair within the RS group is configured. In some scenarios, two RS resources of the RS resource pair are from a same RS set or different RS sets.

In some embodiments of the present application, start time for determining the at least one RS group is configured by media access control (MAC) control element (CE), group common downlink control information (DCI) or dynamic scheduling DCI.

In some embodiments of the present application, stop time for determining the at least one RS group is configured by MAC CE, group common DCI or dynamic scheduling DCI, or is based on a configured or predefined timer.

According to some embodiments of the present application, start of the timer is based on a time instance when determining the at least one RS group starts.

In some embodiments of the present application, the reporting based on at least one of the at least one RS group or the at least one RS set includes reporting at least one of the following: differential reporting metrics with respect to different RS sets; differential reporting metrics with respect to different RS groups; or differential reporting metrics with respect to both different RS sets and different RS groups.

According to some embodiments of the present application, the differential reporting metrics includes at least one of: differential reference signal received power (RSRP), differential reference signal received quality (RSRQ), differential received signal strength indicator (RSSI), differential layer 1-signal to interference plus noise ratio (L1-SINR), differential rank indicator (RI), or differential channel quality indicator (CQI).

According to some embodiments of the present application, the reporting based on at least one of the at least one RS group or the at least one RS set further includes reporting at least one of RS set indexes or RS group indexes. In some scenarios, a number of the at least one of RS set indexes or RS group indexes is configured.

According to some embodiments of the present application, the different RS sets include a configured or predefined reference RS set, and the different RS groups include a configured or predefined reference group.

According to some embodiments of the present application, at least one of: RS set indexes or RS group indexes associated with determining the differential reporting metrics are configured.

According to some embodiments of the present application, the differential reporting metrics are based on a periodic RS resource in a RS set or a RS group and an aperiodic RS resource, and the RS set or RS group is determined based on the periodic RS resource nearest to and earlier than the aperiodic RS.

According to some embodiments of the present application, at least one of: RS set indexes or group indexes associated with determining the differential reporting metrics are based on a reporting identity.

In some embodiments of the present application, a time instance to perform the reporting is configured, or is based on time instance of an aperiodic RS, or is based on an event associated with a differential reporting metric.

Given the above, embodiments of the present application provide a technical solution of supporting spatial element adaption, e.g., CSI and/or SSB measurement and corresponding reporting etc. to adapt the spatial element adjustment, which can save signaling overhead, and thus will facilitate the deployment and implementation of NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 is a schematic diagram illustrating an exemplary wireless communication system according to some embodiments of the present application.

FIG. 2 is a flow chart illustrating an exemplary procedure of a method of supporting spatial element adaption according to some embodiments of the present application.

FIG. 3 is a schematic diagram illustrating determination of RS groups in scenario 2 according to some embodiments of the present application.

FIG. 4 is a schematic diagram illustrating determination of RS groups in scenario 3 according to some embodiments of the present application.

FIG. 5 is a schematic diagram illustrating determination of RS groups in scenario 3 according to some other embodiments of the present application.

FIG. 6 illustrates a block diagram of an exemplary apparatus of supporting spatial element adaption according to some embodiments of the present application.

FIG. 7 illustrates a block diagram of an exemplary apparatus of supporting spatial element adaption according to some other embodiments of the present application.

### DETAILED DESCRIPTION

The detailed description of the appended drawings is intended as a description of the preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G, 3GPP LTE, and so on. It is contemplated that along with the developments of network architectures and new service scenarios, all embodiments in the present application are also applicable to similar technical problems; and moreover, the terminologies recited in the present application may change, which should not affect the principle of the present application.

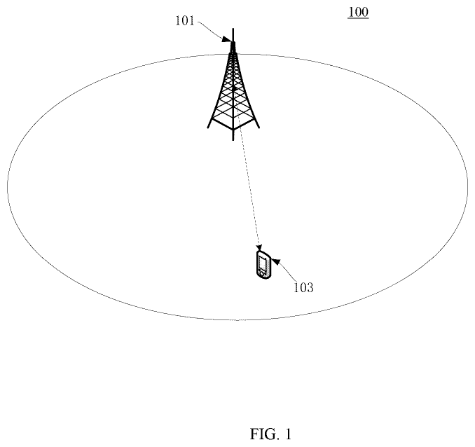

FIG. 1 illustrates a schematic diagram of an exemplary wireless communication system 100 according to some embodiments of the present application.

As shown in FIG. 1, the wireless communication system 100 includes a UE 103 and a base station (BS) 101. Although merely one BS is illustrated in FIG. 1 for simplicity, it is contemplated that the wireless communication system 100 may include more BSs in some other embodiments of the present application. Similarly, although merely one UE is illustrated in FIG. 1 for simplicity, it is contemplated that the wireless communication system 100 may include more UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

In addition, a BS 101 may be configured with one transmit-receive point (TRP) (or panel), i.e., operating in a single-TRP scenario, or multiple TRPs (or panels), i.e., operating in a multi-TRP scenario. That is, one or more TRPs are associated with the BS 101. A TRP can act like a small BS. Two TRPs can have the same cell ID (identity or index) or different cell IDs. Two TRPs can communicate with each other by a backhaul link. Such a backhaul link may be an ideal backhaul link or a non-ideal backhaul link. Latency of the ideal backhaul link may be deemed as zero, and latency of the non-ideal backhaul link may be tens of milliseconds and much larger, e.g. on the order of tens of milliseconds, than that of the ideal backhaul link.

A single TRP can be used to serve one or more UE 103 under the control of a BS 101. In different scenarios, a TRP may be referred to as different terms, which may be represented by a TCI state index or CORESETPoolIndex value etc. It should be understood that the TRP(s) (or panel(s)) configured for the BS 101 may be transparent to a UE 103.

The UE 103 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE 103 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present application, the UE 103 may include wearable devices, such as smart watches, fitness bands, optical head-mounted displays, or the like. Moreover, the UE 103 may be referred to as a subscriber unit, a mobile, a mobile station, a user, a terminal, a mobile terminal, a wireless terminal, a fixed terminal, a subscriber station, a user terminal, or a device, or described using other terminology used in the art.

For example, regarding to spatial elements in the wireless communication system, they generally include antenna element(s), transmission (Tx) radio unit(s) (RU)(s) (with sub-array/full-connection), antenna panel(s), transmit receive point (TRxP)(s) (co-located or geographically separated from each other), and logical antenna port(s) (corresponding to specific signals and channels, also referred to as logic port(s) or antenna port(s)) etc. According to RAN1 #111 agreement, it is needed to further study techniques and enhancements for the adaptation of spatial elements, which includes but not limited to the following aspects:
mechanisms to indicate spatial element adaptation to user equipment (UE)
signaling to update the active channel state information (CSI) reference signal (RS) configurations.
enhancements on CSI-RS (re) configuration, CSI radio resource management (RRM) radio link monitoring (RLM), CSI reporting (e.g., multiple CSI reports), and beam management for gNB to switch between different spatial domain configurations
associated UE behavior in case of spatial element adaptation occurs, if needed, e.g., measurements, CSI feedback, power control, physical uplink shared channel (PUSCH) physical downlink shared channel (PDSCH) repetition, sounding reference signal (SRS) transmission, transmission configuration indication (TCI) configuration, beam management, beam failure recovery, radio link monitoring, cell (re) selection, handover, initial access, etc.

Thus, multiple CSI reports corresponding to different active antenna ports or active TXRU are necessary for gNB decision on spatial domain adaptation. Thus, how to determine CSI measurement resources for the multiple CSI reports and how to determine the corresponding multiple CSI reports should be considered and solved. For example, a more specific issue to be solved is how to decrease signaling overhead corresponding to RS configuration and reporting.

At least considering the above study item, embodiments of the present application propose a technical solution of supporting spatial element adaption, e.g., a method and apparatus of supporting spatial element adaption, which mainly focuses on a determination of measurement resource and reporting to save signaling overhead, including reducing overhead of both measurement resource and reporting, e.g., in the case of multiple CSI reports. The CSI reports can be based on CSI-RS and/or SSB. Exemplary spatial domain adaptation may be adaption for antenna port on and off, or TXRU on and off, or TRP on and off etc.

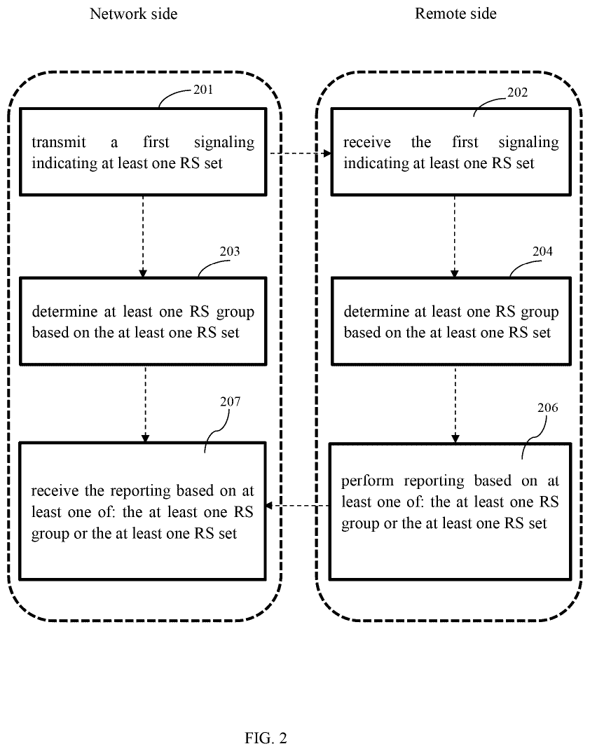

FIG. 2 is a flow chart illustrating an exemplary procedure of a method of supporting spatial element adaption according to some embodiments of the present application. Although the method is illustrated in a system level between a RAN node, e.g., a gNB in the network side and a remote apparatus, e.g., a UE in the remote side, persons skilled in the art should understand that the method implemented in the RAN node and the remote apparatus can be separately implemented and/or incorporated by other apparatus with the like functions.

Referring to FIG. 2, the RAN node, e.g., a gNB may transmit a first signaling, e.g., a radio resource control (RRC) signaling or MAC CE signaling, indicating at least one RS set (each RS or RS resource may be represented by an index etc.) to the remote side, e.g., to a UE in step 201. For example, the first signaling may indicate multiple CSI-RS or SSB sets, or indicate only one CSI-RS or SSB set. Each RS set includes at least one RS resource, e.g., CSI-RS resource or SSB etc., which may be periodic, semi-persistent or aperiodic. In another example, an indicated RS set may include only one RS resource. The number of RS resources in different RS sets may be the same or different. In some embodiments of the present application, each RS set corresponds to a pattern of spatial domain elements, e.g., a spatial domain filter (or beam). In other embodiments, each RS set may correspond to a spatial domain adaptation, e.g. antenna port on or off, TRP on or off, or TXRU on or off. Accordingly, in step 202, the UE will receive the first signaling.

At least one RS groups based on the at least one RS set can be determined for measurement according to various manners. For example, in step 203, the gNB will determine at least one RS group based on the at least one RS set according to various manners; and correspondingly, in step 204, the UE will determine at least one RS group based on the at least one RS set according to various manners. Elements within each RS group may be RS resource(s), or RS resource pair(s), or RS set(s), or port index(es) etc. Two RS resources of each RS resource pair are from the same RS set or different RS sets. Accordingly, each RS group may include one or more separate RS resources, or one or more separate RS resource pairs, or one or more RS sets, or one or more port indexes etc.

Start time and stop time of measurement resource determination based on the at least one RS set, e.g., the time when to start determining the at least one RS group and the time when to stop determining the at least one RS group can be determined in various manners. According to some embodiments of the present application, start time for determining the at least one RS group is configured by the network side, e.g., via MAC CE, group common DCI or dynamic scheduling DCI etc. Similarly, stop time for determining the at least one RS group may also be configured by the network side, e.g., via MAC CE, group common DCI or dynamic scheduling DCI etc. There may be a configured or predefined delay between reception of the signaling and application of the signaling. However, in some other embodiments of the present application, stop time for determining the at least one RS group may be based on a configured or predefined timer. Start of the timer is based on a time instance when determination of the at least one RS group starts, e.g., based on a slot when determination the at least one RS group starts or based on other manners.

In step 206, the UE will perform reporting based on at least one of the at least one RS group or the at least one RS set, e.g., only based on the at least one RS group, only based on the at least one RS set, or based on both the at least one RS group and the at least one RS set etc. The reporting may be for beam management or for CSI reporting etc. Accordingly, the gNB will receive the reporting based on at least one of the at least one RS group or the at least one RS set in step 207. For example, the UE may report multiple CSI reports to the gNB, which are based on multiple CSI-RS groups determined from a plurality of CSI-RS sets.

The reporting based on the at least one RS group or the at least one RS set may be based on differential reporting metric. In some scenarios, the reporting may further include reporting at least one of RS set indexes or RS group indexes. The number of the at least one of RS set indexes or RS group indexes is configured or predefined.

According to some embodiments of the present application, the reporting based on the at least one RS group or the at least one RS set includes reporting at least one of the following: differential reporting metrics with respect to different RS sets (e.g., differential reporting metrics based on RS resources from different RS sets); differential reporting metrics with respect to different RS groups (e.g., differential reporting metrics based on RS resources, RS resource pair, RS resource set or RS port set from different RS groups); or differential reporting metrics with respect to both the different RS sets and the different RS groups (e.g., differential reporting metrics based on RS resources, RS resource pair, or RS port set from different RS groups determined from different RS sets). Exemplary differential reporting metrics include at least one of: differential RSRP, differential RSRQ, differential RSSI, differential L1-SINR, differential RI, or differential CQI etc. For example, the reporting based on at least one of the at least one RS group or the at least one RS set may report differential RSRP between different CSI-RS groups, or report differential RSRP and differential RSRQ between different CSI-RS groups etc.

RS set(s) and/or RS group(s) associated with determining the differential reporting metrics can be determined in various manners. For example, in some embodiments of the present application, RS set indexes and/or RS group indexes associated with determining the differential reporting metrics is configured. In some other embodiments of the present application, the RS set index(es) and/or group index(es) associated with determining the differential reporting metrics are based on a reporting identity. For example, for a RS group with periodic RS resources and a RS group with aperiodic RS resource, in the case that they belong to the same reporting identity, corresponding differential reporting metrics between the two RS groups will be reported. For the comparison based on a periodic RS resource and an aperiodic RS resource, the RS sets and/or RS groups, to which the periodic resource and aperiodic RS resource respectively belong, may also be determined based on the periodic RS resource nearest to and earlier than the aperiodic RS.

Each differential reporting metric associated with a RS set may be generated based on a comparison between the RS set and another corresponding RS set (also referred to as a reference RS set). Similarly, each differential reporting metric associated with a RS group may be generated based on a comparison between the RS group and another corresponding RS group (also referred to as a reference RS group), e.g., a configured or predefined reference RS group. For example, the different RS sets to be compared may include a configured or predefined reference RS set for comparison to determine the differential reporting metrics. Similarly, the different RS groups to be compared may include a configured or predefined reference group for comparison to determine the differential reporting metric.

The reporting based on the at least one RS group and/or the at least one RS set may further include reporting at least one of RS set indexes or RS group indexes, e.g., the index(es) of the RS set(s) with largest reporting metric and/or the index(es) of the RS group(s) with largest reporting metric. According to some embodiments of the present application, the number of the at least one of RS sets (e.g., RS set indexes) or RS groups (e.g., RS group indexes) is configured. For example, in the case that there are 4 CSI-RS groups determined based on multiple CSI-RS sets while the gNB configures the number of RS groups to be reported for each reporting is 2, then the UE will only report two differential reporting metrics associated with two RS groups compared with two reference RS groups (e.g., other two RS groups of the four groups), and report the indexes of the two RS groups with largest reporting metric besides the differential reporting metrics of the two RS groups. As an example, it is supposed that there are group indexes 0, 1, 2, 3. Group indexes 0 and 1 belong to a part of the four groups. Group indexes 2 and 3, as the two reference RS groups, belong to the other part of the four groups. Group index 1 has a larger RSRP value than group index 0, while group index 2 has a larger RSRP value than group index 3. Finally, group indexes 1 and 2 will be reported, given that they are the two groups with largest reporting metric.

The time of reporting can also be determined in various manners. According to some embodiments of the present application, a time instance to perform the reporting is configured, e.g., by a gNB. According to some other embodiments of the present application, a time instance to perform the reporting is based on the time instance of an aperiodic RS. For example: for a periodic RS reporting, based on the triggering of a aperiodic RS reporting, measurement results, based on at least one of the periodic RS and the aperiodic RS, will be reported in the case that the aperiodic RS reporting has the same reporting identity as the periodic RS reporting. For another example: for a periodic RS reporting, based on the triggering of aperiodic RS reporting, measurement results based on at least one of the periodic RS and the aperiodic RS will be reported in the case that both the periodic RS and aperiodic RS belonging to the same RS group. According to some yet other embodiments of the present application, a time instance to perform the reporting is based on an event associated with a differential reporting metric. For example: when the difference between a measurement result based on a non-active RS group and an active RS group is larger than a configured or predefined threshold, a differential reporting metric will be reported. The active RS group may correspond to spatial domain configuration adopted by the network node currently. The non-active RS group may correspond to a spatial domain configuration not adopted by the network currently and may be adopted by the network later or previously. The spatial domain configuration may correspond to antenna port on or off, TXRU on or off, or TRP on or off, etc.

To help understand the technical solution of the present application, more detailed embodiments of the present application will be illustrated in the following. Persons skilled in the art should well know that due to the consistency between the network side and remote side, although some embodiments are illustrated only concerning on one side as an example, the corresponding operations except for special operations in the other side should also be determined. In addition, the measurement resource determination and reporting illustrated herein mainly considers novel parts in view of the adaption of spatial element, and other measurement resource determination and reporting technique applied to the spatial element adaption can also refer to the known art.

### Measurement Resource Determination

As stated above, there are various schemes to determine the measurement resources corresponding to adaptation of spatial domain elements.

For example, according to some embodiments of the present application (scenario 1), at least one RS set indicated by the first signaling will be directly determined as the at least one RS group, that is, the at least one RS group is the same as the at least one RS set indicated by the first signaling, respectively, and the at least one RS set will be used for measurement. For example, a plurality of RS groups for measurement are a plurality of CSI-RS sets configured via a first signaling, and different CSI-RS sets may have the same or different number of RS elements, e.g., a plurality of CSI-RS resources. In the scenarios of multi-TRP, the at least one RS group will be determined for each TRP, e.g., based on respective TRP identity or CORESETPoolIndex value (each corresponding to a TRP) etc.

According to some other embodiments of the present application, the at least one RS group will be determined from the indicated at least one RS set based on additional configured or predefined information (or rules). Further, RS resources (separate or in pairs) from the indicated at least one RS set, or one or more RS sets from the indicated at least one RS set will be determined (or divided or grouped or selected) to generate the at least one RS group. Alternatively, one or more port indexes for each resource from the indicated at least one RS set will be determined (or divided or grouped or selected) to generate the at least one RS group. Therefore each RS group includes one or more RS resources (which may be separate or in pairs), or one or more RS sets, or one or more port indexes. In some scenarios, there may be overlap in slot(s) or symbol(s) for data (and/or channel) and RS groups. An exemplary solution to solve this issue is that the QCL assumption, that is to say, spatial domain relationship for data (and/or channel) will follow that of the RS groups. In the scenarios of multi-TRP, the at least one RS group can be determined for each TRP, e.g., based on respective TRP identity or CORESETPoolIndex value etc., or may be determined based on joint consideration of both single TRP and multi-TRP if possible.

For example, according to some embodiments of the present application, the network side will further configure information for determining the at least one RS group, and indicate the information to the remote side by a second signaling, e.g., another RRC signaling or MAC CE signaling or DCI signaling. Exemplary information includes but not limited to the following:
a) at least one of: a window size of RS set or at least one time instance of RS set; or
b) a window size of RS set and an offset of RS set; or
c) a window size of RS set, an offset of RS set and at least one time instance of RS set; or
d) one or more RS resource indexes within a RS set of the at least one RS set; or
e) a RS set number within a RS group; or
f) a number of time instance of RS set within a RS group; or
g) a RS resource number within a RS group; or
h) a number of RS groups; or
i) a number of elements in each RS group; or
j) at least one port index within each RS resource.

The at least one RS group will be determined based on the at least one RS set and the information indicated in the second signaling. In some scenarios, separate items of the above information can be indicated to the UE for RS group determination. In some other scenarios, a combination of some of the above items can be indicated to the UE for RS group determination.

In some embodiments of the present application (scenario 2), at least one RS group can be determined based on the indicated RS set(s) according to different time domain positions (e.g., time instances etc.). An exemplary scenario is: there is only one RS set configuration, e.g., one CSI-RS resource set configuration, which contains periodic RS resources (or deemed as a RS set which is periodically repeated). For example, in the case that SCS is 15 KHz, the CSI-RS set contain CSI-RS resource #0, #1, #2, #3, the periodicity (or period) of the CSI-RS set as well as each CSI-RS resource is 40 ms, and the offset for each CSI-RS resource is 0 slot, 1 slot, 2 slots, 3 slots, respectively. So the time domain resource for CSI-RS resource #0 will be slot #0,slot #40, slot #80, etc. The time domain resource for CSI-RS resource #1 will be slot #1, slot #41, slot #81, etc. The time domain resource for CSI-RS resource #2 will be slot #2, slot #42, slot #82, etc. The time domain resource for CSI-RS #3 will be slot #3, slot #43, slot #83, etc. At least one RS group can be determined based on the RS set configuration by dividing the periodic RS resources in the RS set (or repeated periodic RS sets) into at least one RS group according to different time domain positions (e.g., time instances). In some embodiments of the present application, the number of elements in each RS group can be configured in the second signaling. For example, the RS set number within a RS group or the number of time instance of RS set within a RS group can be configured in the second signaling. In some other embodiments of the present application, the number of RS groups can be configured in the second signaling. In some yet other embodiments of the present application, a combination of partial of all of the above information can be configured in the second signaling.

In some scenarios, the different time domain positions can also be configured or determined based on the window size and offset (if any, which can be zero). An exemplary window size can be a multiple of periodicity of RS resource in the RS set (which may also be expressed as periodicity of a RS set in some scenarios where the RS set is deemed as periodic). An exemplary offset can also be in unit of periodicity of RS resource in the RS resource set (which may also be expressed as periodicity of a RS set in some scenarios where the RS set is deemed as periodic). For example, in the case that the second signaling indicates the window size, the at least one time instance of RS set will be determined based on the window size. In the case that the second signaling indicates the window size and offset, the at least one time instance of RS set will be determined based on the window size and offset. In the case that the at least one RS resource within a RS set is periodic RS resource, the window size and the offset are in unit of periodicity of the at least one RS resource. In some embodiments of the present application, all of the time instance(s) for grouping the RS sets, the window and the offset (if any, which can be zero) can be configured.

Each periodic RS set (or RS resources within a period) within the window can be associated with the same or different RS groups. Different RS groups can be associated with different spatial domain adaptation, e.g. different antenna port on or off, different TRP on or off, or different TXRU on or off. In the scenarios of multi-TRP, determination of the RS group(s) can be based on each TRP, e.g., based on respective TRP identity or CORESETPoolIndex value etc.; or determination of the RS group(s) for both single TRP and multi-TRP can be considered jointly.

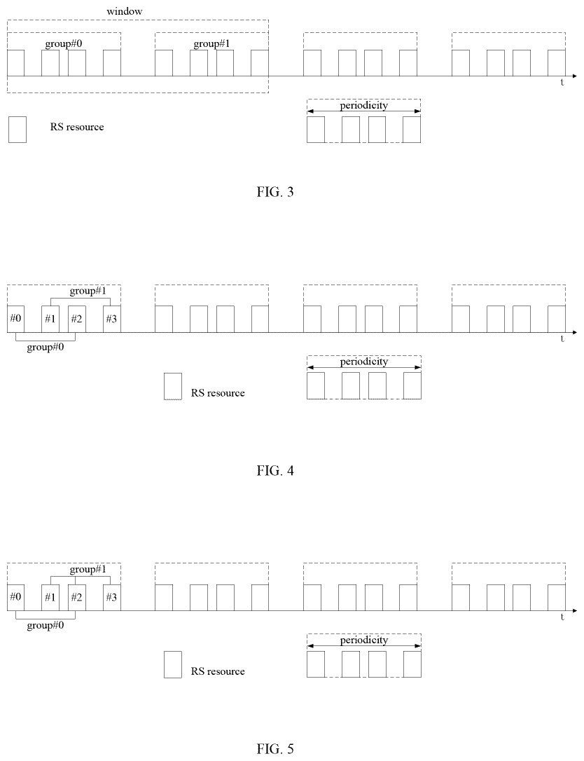

FIG. 3 is a schematic diagram illustrating determination of RS groups in scenario 2 according to some embodiments of the present application.

As shown in FIG. 3, there is one RS set configuration, e.g., one CSI-RS resource set configuration configuring a CSI-RS resource set, and the CSI-RS resource set is periodically repeated. It is assumed that, the window size is double of the periodicity (or two periods) of the CSI-RS set, and the offset is zero. The number of RS set within a RS group is 1. Then, two CSI-RS groups, e.g., group #0 and group #1 can be determined, each including a RS set.

On the other hand, the RS set configuration can also be expressed as a RS set with a plurality of periodic RS resources. It is assumed that the window size is double of the periodicity of the RS resource within the RS set, and the offset is zero. The number of time instances of RS set per RS group is 1. Then, two CSI-RS groups, e.g., group #0 and group #1 can be determined, each including 4 RS resources within a periodicity.

In some other embodiments of the present application (scenario 3), at least one RS group can be determined based on the indicated RS set(s) according to different RS resources, e.g., according to RS resource indexes etc. An exemplary scenario is: there is only one RS set configuration, e.g., one CSI-RS resource set configuration, which configures a RS set with periodic RS resources (or deemed as a RS set which is periodically repeated). Another exemplary scenario is: there is only one RS set configuration, e.g., one CSI-RS resource set configuration, which configures a RS set with aperiodic CSI-RS resources. According to some embodiments of the present application, at least one RS group can be determined based on the RS set configuration by dividing the periodic RS resources in the RS set (or repeated periodic RS sets) into at least one RS group according to RS resources, e.g., according to RS resource indexes etc. Different RS groups can be associated with different spatial domain adaptation. Elements of each RS group may be separate RS resources (or RS resource indexes), e.g., one or more CSI-RS resources; or may be RS resource pairs (or RS resource index pair), e.g., one or more CSI-RS resource pairs.

For example, in some embodiments of the present application, one or more RS resource indexes within a RS set can be configured in the second signaling, which is used for a RS group. In some other embodiments of the present application, the element number, e.g., RS resource number within a RS group can be configured in the second signaling. In some yet other embodiments of the present application, a number of RS groups can be configured in the second signaling. In some yet other embodiments of the present application, the number of RS groups and/or the number of elements in each RS group can be configured in the second signaling.

In the scenarios of multi-TRP, determination of the RS group(s) can be based on each TRP, e.g., based on respective TRP identity or CORESETPoolIndex value etc.; or determination of the RS group(s) for both single TRP and multi-TRP can be considered jointly. In some embodiments of the present application, in the case of jointly determination of the RS group(s) for both single TRP and multi-TRP, each element in each RS group is a RS resource pair. Each RS resource of the RS resource pair correspond to a TRP. The RS resource pair index(es) for each RS group can be configured by the network side, e.g., by the gNB via the second signaling.

There may be partial overlap or non-overlap between elements, e.g., RS resources (e.g., RS resource indexes) of different RS groups, that is, different RS groups include partial identical or totally different RS resources. For both beam management and CSI measurement, the partial overlap case can be applied to scenarios where beam width is not changed and only beam number is changed, while the non-overlap case can be applied to scenarios where both beam width and beam number is changed.

FIG. 4 is a schematic diagram illustrating determination of RS groups in scenario 3 according to some embodiments of the present application, wherein there is non-overlap between RS resources of different RS groups.

As shown in FIG. 4, there is one RS set configuration, e.g., one CSI-RS resource set configuration configuring a CSI-RS resource set, and the CSI-RS resource set is periodically repeated. On the other hand, the RS set configuration can also be expressed as a RS set with a plurality of periodic RS resources. It is assumed that, two RS groups will be determined, wherein, two RSs (or a RS pair in multi-TRP scenarios) including RS resources #0 and #2 are configured for a first RS group, e.g., group #0; and other two RSs (or another RS pair in multi-TRP scenarios) including RS resources #1 and #3 are configured for a second RS group, e.g., group #1. Thus, different RS groups include totally different RS resources.

FIG. 5 is a schematic diagram illustrating determination of RS groups in scenario 3 according to some other embodiments of the present application, wherein there is partial overlap between RS resources of different RS groups.

As shown in FIG. 5, there is one RS set configuration, e.g., one CSI-RS resource set configuration configuring a CSI-RS resource set, and the CSI-RS resource set is periodically repeated. On the other hand, the RS set configuration can also be expressed as a RS set with a plurality of periodic RS resources. It is assumed that, two RS groups will be determined, wherein, two RSs including RS resources #0 and #2 are configured for a first RS group, e.g., group #0, and three RSs including RS resources #1, #2 and #3 are configured for a second RS group, e.g., group #1. Thus, the two RS groups are partially overlapped, due to both including RS #2.

In some yet other embodiments of the present application (scenarios 4), at least one RS group can be determined based on the indicated RS set according to different port indexes within each resource. An exemplary scenario is: there is only one RS set configuration, e.g., one CSI-RS resource set configuration, which configures a RS set with periodic RS resources (or deemed as a RS set which is periodic) or one or more non-periodic RS resources. Another exemplary scenario is: there is only one RS set configuration, e.g., one CSI-RS resource set configuration, which configures a RS set with aperiodic RS resources. In the case that an exemplary RS set configuration configures a RS set with only one RS, the RS set configuration can also be deem as a RS configuration, e.g., one CSI-RS resource configuration, which configures one CSI-RS resource.

Each RS group includes one or more port indexes within a resource (indicated one resource or a resource within an indicated RS set). In some embodiments of the present application, at least one port index within each RS resource can be configured in the second signaling. Different RS groups can be associated with different spatial domain adaptation, e.g., TXRU corresponding to an antenna port being all set off. Transmission of RS(s) from the network side is based on the largest port index. There may be partial overlap or non-overlap between port indexes of different RS groups, that is, different RS groups include partial identical or totally different port indexes. In the scenarios of multi-TRP, determination of the RS group(s) can be based on each TRP, e.g., based on respective TRP identity or CORESETPoolIndex value etc.

### RS Reporting

The UE will perform reporting based on at least one of the at least one RS group or the at least one RS set, e.g., reporting at least one of the following: differential reporting metrics with respect to different RS sets; differential reporting metrics with respect to different RS groups; or differential reporting metrics with respect to both the different RS sets and the different RS groups. The RS group(s) and/or RS set(s) in each comparison as a reference (reference RS set(s) or reference RS group(s)) can be configured or implicitly determined in various manners, e.g., by configured RS set indexes and/or group indexes or the number of RS set indexes and/or group indexes etc. The RS group(s) and/or RS set(s) in each comparison to report its differential reporting metric (reported RS set(s) or reported RS group(s)) can also be configured or implicitly determined in various manners, e.g., by configured RS set indexes and/or group indexes or the number of RS set indexes and/or group indexes. In some embodiments of the present application, all the RS sets and/or the determined RS group(s) can be used for comparison (as a reference RS set and/or a reference RS group, or as a reported RS set and/or reported RS group), while in some other embodiments of the present application, only part of the RS sets and/or the determined RS group(s) can be used for comparison.

Specifically, in some scenarios, the comparison is among periodic resources. Considering scenario 1 in measurement resource determination, at least one RS set index (or group index) can be configured as a reference RS set or as a RS set to reporting its differential reporting metric. For scenarios 2-4 in measurement resource determination, part or all of the RS groups can be used for comparison. For example, at least one RS group index for comparison (or for reporting) or the number of RS groups for comparison (or for reporting) can be configured by the network side. For example, there are 4 RS groups, e.g., group #0, group #1, group #2 and group #3 determined in scenarios, and the number of report is configured to be 2. Then, the comparison will be between each two RS group according to additional configuration information (or rules) or predefined information (or rules) to generate two reports, e.g., between group #0 and group #1, and between subset #2 and subset #3. Which one of group #0 and group #1, and which one of group #2 and group #3 act as the reference RS group or the reported RS group can be determined based on configured information (or rules) or predefined information (or rules).

In some other scenarios, the comparison is between periodic RS in a RS set or RS group and aperiodic RS in a RS set or RS group. According to some embodiments of the present application, the comparison can be based on the measurement result of aperiodic RS and the nearest periodic RS, wherein the periodic RS is before the aperiodic RS. According to some other embodiments of the present application, the periodic RS and aperiodic RS may be associated with the same reporting identity, and then the comparison result, e.g., differential reporting metric between the periodic RS and aperiodic RS will be reported.

In the case of RS reporting for beam management, at least one of: differential RSRP, differential RSRQ, differential RSSI, or differential L1-SINR between different RS groups will be reported. In some embodiments of the present application, RS group index(es) associated with the reporting will also be reported to the network side. How many RS groups will be reported, which may be with or without corresponding reporting metric(s), e.g., RSRP, RSRQ, RSSI, and/or L1-SINR etc. can be configured by the network side. Exemplary reporting metric(s), e.g., RSRP, RSRQ, RSSI, and/or L1-SINR of a RS group may be determined based on the best value among all resources of a RS group or based on the average of the best N values of reporting metrics among all resources of the RS group, wherein N is an configured or predefined integer larger than or equal to 1. It is similar for differential reporting metrics between different RS sets.

In the scenarios of multi-TRP for beam management, the reporting can be performed per TRP or among different TRPs.

In the case that the reporting is per TRP, considering scenarios 2-4 in measurement determination, each TRP can be associated with a RS set, while RS group reporting can be performed separately for each RS set.

In the case that the reporting is among multiple TRPs, considering scenarios 2-4 in measurement determination, in the case that each TRP is associated with a RS set, the reporting will also include the set index in addition to the reporting metric, e.g., differential reporting metric for RS group(s) (or RS group index). The differential reporting metric is between different RS groups of different RS sets. In some embodiments of the present application, both RS set index and RS group index are reported as a pair. The corresponding differential reporting metric may also be reported together with the RS set index and RS group index. In some other embodiments of the present application, the RS set index and RS group index may correspond to different bit fields. For example, the set index is reported in a first field, and the RS group index associated with the set index is reported in a second field. The corresponding reporting metric may also be reported together with the RS group index.

In the case of RS reporting for CSI reporting, at least one of: differential value of RI, precoding matrix indicator (PMI), channel quality indication (CQI), layer indication (LI) between different RS groups will be reported. If one RS group has one CQI, and another RS group for comparison has two CQI, only the first corresponding CQI will be used for determined the differential value. Regarding PMI, RI and LI etc., they will be reported based on each RS group. In some embodiments of the present application, RS group index(es) associated with the reporting will also be reported to the network side. How many RS groups will be reported, which may be with or without corresponding reporting metric(s), e.g., RI, PMI, CQI, and/or LI etc. can be configured or predefined by the network side. Exemplary reporting metric(s) of a RS group, e.g., RI and/or CQI etc. can be determined based on the best value of the RI and/or CQI among all resources of a RS group, or based on average of the best N values of the RI and/or CQI among all resources of the RS group. It is similar for differential reporting metrics between different RS sets.

In the scenarios of multi-TRP for CSI reporting, the differential reporting metrics, e.g., differential RI and CQI can be for RS groups for a single RS resource corresponding to a single TRP. In some other embodiments of the present application, the differential reporting metrics, e.g., differential RI and CQI can also be between both different RS sets and different RS groups for comparison between different TRPs. Additionally, there can be reporting metrics, e.g., differential RI and CQI between RS groups constructed by different set indexes and different resource pair indexes. An exemplary resource pair index can also be represented by a set index. For example, a

RS set index corresponding to a first TRP is 0, a set index corresponding to a second TRP is 1, and a set index corresponding to resource pair for both the first and second TRP is 2. Accordingly, the RS set index and RS group index can also be reported in the same field, e.g., as a pair, or in different bit fields.

Besides the methods, embodiments of the present application also propose an apparatus of supporting spatial element adaption.

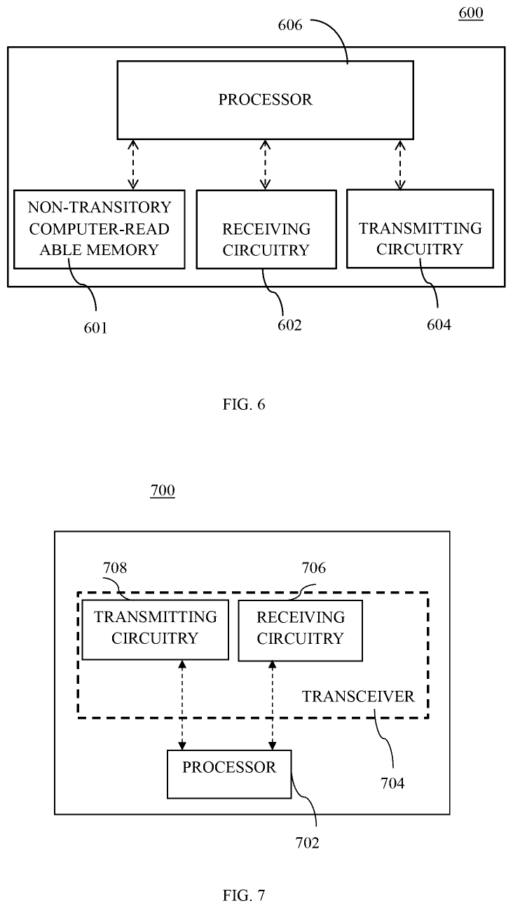

For example, FIG. 6 illustrates a block diagram of an apparatus of supporting spatial element adaption 600 according to some embodiments of the present application.

As shown in FIG. 6, the apparatus 600 may include at least one non-transitory computer-readable medium 601, at least one receiving circuitry 602, at least one transmitting circuitry 604, and at least one processor 606 coupled to the non-transitory computer-readable medium 601, the receiving circuitry 602 and the transmitting circuitry 604. The at least one processor 606 may be a central processing unit (CPU), a digital signaling processing (DSP), a microprocessor etc. The apparatus 600 may be a RAN node, e.g., a gNB or a remote apparatus, e.g., a UE configured to perform a method illustrated in the above or the like.

Although in this figure, elements such as the at least one processor 606, transmitting circuitry 604, and receiving circuitry 602 are described in the singular, the plural is contemplated unless a limitation to the singular is explicitly stated. In some embodiments of the present application, the receiving circuitry 602 and the transmitting circuitry 604 can be combined into a single device, such as a transceiver. In certain embodiments of the present application, the apparatus 600 may further include an input device, a memory, and/or other components.

In some embodiments of the present application, the non-transitory computer-readable medium 601 may have stored thereon computer-executable instructions to cause a processor to implement the method with respect to the RAN node, e.g., the gNB as described above. For example, the computer-executable instructions, when executed, cause the processor 606 interacting with receiving circuitry 602 and transmitting circuitry 604, so as to perform the steps with respect to the RAN node as depicted above.

In some embodiments of the present application, the non-transitory computer-readable medium 601 may have stored thereon computer-executable instructions to cause a processor to implement the method with respect to the remote apparatus, e.g., the UE as described above. For example, the computer-executable instructions, when executed, cause the processor 606 interacting with receiving circuitry 602 and transmitting circuitry 604, so as to perform the steps with respect to the remote apparatus as illustrated above.

FIG. 7 is a block diagram of an apparatus of supporting spatial element adaption 700 according to some other embodiments of the present application.

Referring to FIG. 7, the apparatus 700, for example a RAN node or a UE may include at least one processor 702 and at least one transceiver 704 coupled to the at least one processor 702. The transceiver 704 may include at least one separate receiving circuitry 706 and transmitting circuitry 704, or at least one integrated receiving circuitry 706 and transmitting circuitry 704. The at least one processor 702 may be a CPU, a DSP, a microprocessor etc.

According to some embodiments of the present application, the apparatus 700 is a RAN node, e.g., a gNB, which includes: a transceiver; and a processor coupled to the transceiver, wherein the processor is configured to: transmit a first signaling indicating at least one RS set, wherein, each RS set includes at least one RS resource; determine at least one RS group based on the at least one RS set; and receive reporting based on at least one of the at least one RS group or the at least one RS set.

According to some embodiments of the present application, the apparatus 700 is a remote apparatus, e.g., a UE, which includes: a transceiver; and a processor coupled to the transceiver, wherein the processor is configured to: receive a first signaling indicating at least one RS set, wherein, each RS set includes at least one RS resource; determine at least one RS group based on the at least one RS set; and perform reporting based on at least one of: the at least one RS group or the at least one RS set.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as random access memory (RAMs), read only memory (ROMs), flash memory, electrically erasable programmable read only memory (EEPROMs), optical storage devices (compact disc (CD) or digital video disc (DVD)), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A user equipment (UE) for wireless communication, comprising:
at least one memory; and
at least one processor coupled with the at least one memory and configured to cause the UE to:
receive a first signaling indicating at least one reference signal (RS) set, wherein each RS set includes at least one RS resource;
determine at least one RS group based on the at least one RS set; and
perform reporting based on the at least one RS group or the at least one RS set.

2. The UE of claim 1, wherein the at least one processor is further configured to cause the UE to:
receive a second signaling indicating of the following:
a window size of an RS set or at least one time instance of the RS set;
a window size of the RS set and an offset of the RS set;
a window size of the RS set, an offset of the RS set and at least one time instance of the RS set;
one or more RS resource indexes within an RS set of the at least one RS set;
an RS set number within an RS group;
a number of time instances of an RS set within an RS group;
an RS resource number within an RS group;
a number of RS groups;
a number of elements in each RS group;
at least one port index within each RS resource; and
determine the at least one RS group based on the at least one RS set and the information indicated in the second signaling.

3. The UE of claim 2, wherein, when the second signaling indicates the window size, the at least one time instance of the RS set is determined based on the window size.

4. The UE of claim 1, wherein each element in an RS group of the at least RS group is an RS resource pair.

5. The UE of claim 4, wherein two RS resources of the RS resource pair are from a same RS set or from different RS sets.

6. The UE of claim 1, wherein a start time for determining the at least one RS group is configured by a media access control (MAC) control element (CE), group common downlink control information (DCI), or dynamic scheduling DCI.

7. The UE of claim 1, wherein a stop time for determining the at least one RS group is configured by a media access control (MAC) control element (CE), group common downlink control information (DCI), or dynamic scheduling DCI, or is based on a configured or predefined timer.

8. The UE of claim 1, wherein the at least one processor is configured to perform the reporting based on at least one of the at least one RS group or the at least one RS by reporting:
differential reporting metrics with respect to different RS sets;
differential reporting metrics with respect to different RS groups; or
differential reporting metrics with respect to both different RS sets and different RS groups.

9. The UE of claim 8, wherein the reporting includes RS set indexes or RS group indexes.

10. The UE of claim 8, wherein the different RS sets include a configured or predefined reference RS set, and the different RS groups include a configured or predefined reference group.

11. The UE of claim 8, wherein the differential reporting metrics are is-based on a periodic RS resource in an RS set or an RS group and an aperiodic RS resource, and the RS set or RS group is determined based on the periodic RS resource nearest to and earlier than the aperiodic RS.

12. The UE of claim 8, wherein RS set indexes or group indexes associated with determining the differential reporting metrics are based on a reporting identity.

13. The UE of claim 1, wherein a time instance to perform the reporting is configured, or is based on a time instance of an aperiodic RS, or is based on an event associated with a differential reporting metric.

14. A radio access network (RAN) node for wireless communication, comprising:
at least one memory; and
at least one processor coupled with the at least one memory and configured to cause the RAN node to:
transmit a first signaling indicating at least one reference signal (RS) set, wherein each RS set includes at least one RS resource;
determine at least one RS group based on the at least one RS set; and
receive reporting based on at least one of the at least one RS group or the at least one RS set.

15. A method performed by a user equipment (UE), the method comprising:
receiving a first signaling indicating at least one reference signal (RS) set, wherein each RS set includes at least one RS resource;
determining at least one RS group based on the at least one RS set; and
performing reporting based on at least one of: the at least one RS group or the at least one RS set.

16. The method of claim 15, wherein the at least one processor is further configured to cause the UE to:
receive a second signaling indicating the following:
a window size of an RS set or at least one time instance of the RS set;
a window size of the RS set and an offset of the RS set;
a window size of the RS set, an offset of the RS set and at least one time instance of the RS set;
one or more RS resource indexes within an RS set of the at least one RS set;
an RS set number within an RS group;
a number of time instances of an RS set within an RS group;
an RS resource number within an RS group;
a number of RS groups;
a number of elements in each RS group; or
at least one port index within each RS resource; and
determine the at least one RS group based on the at least one RS set and the information indicated in the second signaling.

17. The method of claim 16, wherein, when the second signaling indicates the window size, the at least one time instance of the RS set is determined based on the window size.

18. The method of claim 15, wherein each element in an RS group of the at least RS group is an RS resource pair.

19. The method of claim 18, wherein two RS resources of the RS resource pair are from a same RS set or from different RS sets.

20. A method performed by a radio access network (RAN) node, the method comprising:
transmitting a first signaling indicating at least one reference signal (RS) set,
wherein each RS set includes at least one RS resource;
determining at least one RS group based on the at least one RS set; and
receiving reporting based on at least one of the at least one RS group or the at least one RS set.
